(19) United States
(12) Patent Application Publication
(10) Pub. No.: US 2013/0027960 A1
(43) Pub. Date: Jan. 31, 2013

(54) LIGHTING AND/OR SIGNALING DEVICE FOR A MOTOR VEHICLE INCLUDING A SURFACE LIGHT SOURCE

(71) Applicants: Christophe Dubosc, Villemomble (FR); Pierre Albou, Paris (FR); Vincent Godbillon, Paris (FR)

(72) Inventors: Christophe Dubosc, Villemomble (FR); Pierre Albou, Paris (FR); Vincent Godbillon, Paris (FR)

(73) Assignee: VALEO VISION, Bobigny Cedex (FR)

(21) Appl. No.: 13/575,109

(22) PCT Filed: Feb. 18, 2011
(86) PCT No.: PCT/EP2011/052394

§ 371 Date: Oct. 16, 2012

(30) Foreign Application Priority Data
Mar. 5, 2010 (FR) 1051610

(51) Int. Cl. F21S 8/10; F21V 5/04

(52) U.S. Cl. 362/520; 362/543; 362/545

(57) ABSTRACT

An optical device for a motor vehicle, in particular a lighting and/or signaling device for a motor vehicle, comprising a main light source and an auxiliary light source, wherein the auxiliary light source comprises a surface light source.

### CROSS-REFERENCE TO RELATED APPLICATIONS

This application claims priority to PCT Application PCT/EP2011/052394 filed Feb. 18, 2011, and also to French Application No. 1051610 filed Mar. 5, 2010, which applications are incorporated herein by reference and made a part hereof.

### BACKGROUND OF THE INVENTION

1. Field of the Invention

The present invention relates to an optical device, in particular for a motor vehicle, such as a lighting and/or signaling device having in particular a photometric function that is useful when the vehicle is moving on the road, allowing the vehicle to be seen by other vehicles or allowing the driver of the vehicle to see outside.

2. Description of the Related Art

In the signaling field, just as in the lighting field, there are a large number of regulations which do not leave much room for modifying the appearance of lamps in the on state, since the photometry of the light beams is enforced to a very large extent. However, style and aesthetics are very important factors for this type of product, and motor vehicle manufacturers try to give a “signature” to their products so that they can be easily identified by the end user. However, although this “signature” is clear during the day when the lamp or headlamp is off, the same is not true at night when they are on. This is because, at night the lighting and/or signaling devices are generally not visible over their entire outer surface: only the illuminating areas of the basic optical functions are lit up. Thus, a signaling lamp is made up of several illuminating areas which correspond to the various optical functions to be implemented, including continuously-on functions, such as the position lamp function, and only intermittently-on functions, such as the stop lamp function, for example.

Lighting and/or signaling devices therefore actually have two very different appearances according to whether they are on or off. The present trend to increase the surface area of headlamps and lamps only further accentuates this difference. This is particularly the case with lamps having a large outer surface area, of the “wrap-around” lamp type, i.e. lamps which extend not only over the front or rear face of the vehicle but also over the side thereof at the connecting part of a wing with this front or rear face: in this specific case, there is often great disparity between the useful lit-up surface area and the full outer surface area of the lamp.

There is therefore a tendency at night to lose the “signature” of lighting and/or signaling devices. Moreover, and more generally, there is a need to better diversify/adjust the appearance of lighting and/or signaling devices when at least one of their optical functions is on.

To address this problem, there is known from document EP 1 434 000, which is equivalent to U.S. Patent Publications 2004/0136203 and 2007/0008736 and to U.S. Pat. Nos. 7,111,970 and 7,278,768, which documents are incorporated herein by reference and made a part hereof, a signaling device comprising a light source providing a signaling function and a screen covering this light source. This screen actually forms a light guide for guiding the light from another light source provided on a periphery of the screen up to diffusion foci provided on the screen in order that, at these places, the light generated by the other light source can exit the screen and thus be visible. Nevertheless, such a solution poses a certain number of problems, in particular problems of complexity of implementation. Specifically, on the one hand, the other light source must be provided and arranged on the periphery of the screen, and on the other hand, a certain number of patterns or reliefs must be made on the screen to allow the light to exit the screen. These constraints make the signaling device difficult to implement and expensive.

### SUMMARY OF THE INVENTION

One aim of the invention is to improve the appearance of lighting and/or signaling devices, and more particularly to give a homogeneous luminous appearance in any direction of observation, with greater freedom of form, especially when they are at least partly on, without necessarily complicating their implementation and increasing their cost.

According to the invention, the optical device for a motor vehicle, in particular a lighting and/or signaling device for a motor vehicle, comprises a main light source and an auxiliary light source. The auxiliary light source comprises a surface light source. The aesthetics of the lighting and/or signaling device can be improved by the presence of a surface light source. In particular, owing to this presence, the appearance of the lighting and/or signaling device can be modified when the latter is activated.

The main light source and the auxiliary light source preferably do not provide more than one lighting and/or signaling function. If necessary, the auxiliary light source completes the main light source to provide the lighting and/or signaling function. Preferably, the main and auxiliary light sources are activated simultaneously.

According to one embodiment, the main light source emits light rays and produces the greater part of the light for providing a lighting and/or signaling function. Preferably, the main light source produces the entire light for providing the lighting and/or signaling function. The photometry of the lighting and/or signaling function is therefore substantially, or even fully, provided by the main source. The auxiliary light source emits light rays and produces a particular lit effect of the lighting and/or signaling device. The purpose of the auxiliary light source is to produce the signature of the device, such as giving a particular lit appearance to the device. In particular, the auxiliary light source can provide for making the appearance of the lighting and/or signaling device homogeneous when the latter is on. Preferably, the two sources are on simultaneously and of the same color.

Embodiments can also be envisaged in which the main source or sources produce a first photometric function and the auxiliary source or sources produce a second photometric function that is different from the first. These photometric functions are preferably lighting and/or signaling functions. For example, the main source or sources can produce a position lamp type function and the auxiliary source or sources a side-marker lamp type function, which indicates the width of the vehicle.

The area of emission of the surface light source can be greater than 1 cm², or even greater than 10 cm².

The surface light source preferably comprises an organic light-emitting diode. This technology exhibits a number of advantages, it is developing rapidly and its cost is decreasing. The organic light-emitting diode can be Lambertian.

The organic light-emitting diode is preferably conformable. In particular, it can consist of a deformable film applied on a surface of a transparent part or it can be printed onto a surface of a transparent part. Thus, the surface of the light-emitting diode can be warped.

The lighting and/or signaling device preferably comprises a housing closed by a cover lens, inside of which housing are located the main and auxiliary sources.

The auxiliary light source can be placed between the cover lens and the main light source and the auxiliary light source can be of the transparent type. Thus, a homogeneous appearance of the lighting and/or signaling device is obtained. The light rays emitted by the main light source must pass through the auxiliary light source before reaching the cover lens.

The main light source can be placed between the cover lens and the auxiliary light source. Thus, the light rays emitted by the main light source can reach the cover lens directly. The main and auxiliary sources exhibit different, or even very different, areas. Thus, although the main source is located in between the auxiliary source and the cover lens, it is possible to see the auxiliary source located behind the main source.

The auxiliary light source can exhibit a cutout in which the main light source is arranged. Thus, just as previously, the light rays emitted by the main light source can reach the cover lens directly. The main and auxiliary sources exhibit different, or even very different, areas. Thus, the auxiliary source remains visible.

The main light source can be arranged at an edge of the lighting and/or signaling device and/or at an edge of the auxiliary light source.

The main light source can comprise several elements emitting light. Thus, different zones can be formed, these zones emitting light rays of different colors and/or being activated independently of one another.

The auxiliary light source can comprise several surface elements emitting light, in particular several organic light-emitting diodes. Thus, different zones can be formed, these zones emitting light rays of different colors and/or being activated independently of one another. These different zones can provide for following more closely the curve of a cover lens.

The main light source and the auxiliary light source can be activated simultaneously.

Preferably, the greater part of a lighting and/or signaling function is provided by the main source.

The device is preferably intended to provide a signaling function for a motor vehicle.

In a plane perpendicular to the optical axis of the device, the sum of the areas of the projected surfaces, in particular in a plane perpendicular to the optical axis of the device, of the main and auxiliary sources can be greater than 50%, or indeed greater than 60%, of the area of the surface of a quadrilateral containing these projected surfaces of the main and auxiliary sources.

Preferably, the maximum distance between the auxiliary and main sources is 20 mm and preferably 15 mm. The advantage being to improve the legibility of the function or functions by the other drivers, who in a given direction have all the signaling information.

Another subject of the invention is a motor vehicle comprising a lighting and/or signaling device as defined previously.

These and other objects and advantages of the invention will be apparent from the following description, the accompanying drawings and the appended claims.

### BRIEF DESCRIPTION OF THE ACCOMPANYING DRAWINGS

The accompanying drawings represent, by way of examples, various embodiments of a lighting and/or signaling device for a motor vehicle according to the invention.

FIG. 1 is a cross-section block diagram of a first embodiment of a lighting and/or signaling device according to the invention;

FIG. 2 is a face-view block diagram (without the housing) of the first embodiment of a lighting and/or signaling device according to the invention;

FIG. 3 is a cross-section block diagram of a second embodiment of a lighting and/or signaling device according to the invention;

FIG. 4 is a face-view block diagram (without the housing) of the second embodiment of a lighting and/or signaling device according to the invention;

FIG. 5 is a cross-section block diagram of a third embodiment of a lighting and/or signaling device according to the invention;

FIG. 6 is a face-view block diagram (without the housing) of the third embodiment of a lighting and/or signaling device according to the invention;

FIG. 7 is a cross-section block diagram of a fourth embodiment of a lighting and/or signaling device according to the invention;

FIG. 8 is a face-view block diagram (without the housing) of the fourth embodiment of a lighting and/or signaling device according to the invention;

FIG. 9 is a front perspective view of a fifth embodiment of a lighting and/or signaling device according to the invention;

FIG. 10 is a rear perspective view of the fifth embodiment of the lighting and/or signaling device according to the invention;

FIG. 11 is a face view of the fifth embodiment of the lighting and/or signaling device according to the invention;

FIG. 12 is a vertical cross-section view of the fifth embodiment of the lighting and/or signaling device according to the invention;

FIG. 13 is a block diagram of an embodiment of a surface light source able to be used for implementing a lighting and/or signaling device according to the invention; and

FIG. 14 is a block diagram of an embodiment of another surface light source able to be used for implementing a lighting and/or signaling device according to the invention.

### DETAILED DESCRIPTION OF THE PREFERRED EMBODIMENTS

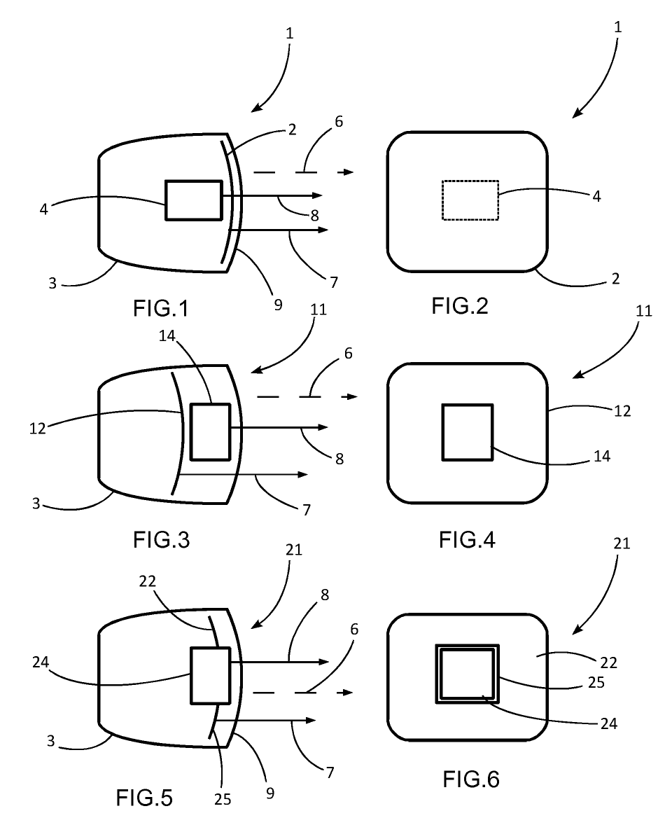

In a first embodiment, described hereafter with reference to FIGS. 1 and 2, the optical device is a lighting and/or signaling device 1 comprises a housing 3 closed by a cover lens 9. The lighting and/or signaling device 1 comprises at least one main light source 4 and at least one auxiliary light source 2. The main light source 4 emits light rays 8 and produces the greater part of the light for providing a lighting and/or signaling function. Preferably, the main light source 4 produces the entire light for providing the lighting and/or signaling function. Preferably, the auxiliary light source 2 emits light rays 7 and produces a particular lit effect of the lighting and/or signaling device 1. In particular, the auxiliary light source 2 can provide for making the appearance of the lighting and/or signaling device 1 homogeneous when the latter is on.

In this first embodiment, the auxiliary light source 2 is placed between the cover lens 9 and the main light source 4. Thus, the light rays 7 emitted by the auxiliary light source 2 reach the cover lens 9 directly in order to exit the lighting and/or signaling device 1. However, the light rays 8 emitted by the main light source 4 reach the cover lens 9 indirectly: they must pass through the auxiliary light source 2 beforehand. Also, in this first embodiment, the auxiliary light source 2 must be of the transparent type. It preferably comprises an organic light-emitting diode having two transparent electrodes. Since the main light source 4 is located behind the auxiliary light source 2, it is represented in dotted line in FIG. 2. It is to be noted that a part of the light rays is absorbed when passing through the auxiliary light source 2. In this first embodiment, the main light source 4 is positioned behind the auxiliary light source 2 relative to the direction or directions of emission of light from the auxiliary light source 2. The lighting and/or signaling device 1 has an optical axis 6.

In a second embodiment, described hereafter with reference to FIGS. 3 and 4, the lighting and/or signaling device 11 differs from that described previously in that the main light source 14 is inserted between the cover lens 9 and the auxiliary light source 12. Thus, the light rays 8 emitted by the main light source 14 reach the cover lens 9 directly in order to exit the lighting and/or signaling device 11. However, only the light rays 7 emitted by the auxiliary light source 12 and located around the main light source 14 reach the cover lens 9. A part of the light rays 7 emitted by the auxiliary light source 12 happens to be stopped by the main light source 14. Since the auxiliary light source 12 is located behind the main light source 14, the latter is represented in solid line in FIG. 4.

In a third embodiment, described hereafter with reference to FIGS. 5 and 6, the lighting and/or signaling device 21 differs from those described with reference to FIGS. 1 to 4 in that main light source 24 is located at least substantially at the same level as the auxiliary light source 22. In particular, the main light source 24 can be located in the same plane as the auxiliary light source 22. For example, a cutout 25 is made in the auxiliary light source 22. Thus, the main light source 24 can be arranged in the cutout 25. The light rays 8 emitted by the main light source 24, like the light rays 7 emitted by the auxiliary light source 22, reach the cover lens 9 directly in order to exit the lighting and/or signaling device 21. The auxiliary light source 22 surrounds the main light source 24. The main light source 24 provides the photometry of the lighting and/or signaling function and the auxiliary light source 22 produces the signature of the lighting and/or signaling device 21. This signature is produced by the lighting-up of a surface surrounding the main light source 24.

In two variant embodiments, the auxiliary light source 24 exhibits a cutout 25, such as in accordance with an example of the third embodiment, but the main light source 24 is in front of or behind the opening created by the cutout 25. For example, according to a first variant embodiment, it is possible to substitute the auxiliary light source 22 of the third embodiment for the auxiliary light source 2 of the first embodiment. Compared with the first embodiment, the photometric output of this first variant will be improved. This is because, in this variant, there is no loss of light emitted by the main light source 24 while passing through the auxiliary light source 22. According to a second variant embodiment, it is possible to substitute the auxiliary light source 22 of the third embodiment for the auxiliary light source 12 of the second embodiment. In these two variants, the cost is reduced since the auxiliary light source 22 exhibits a reduced productive surface, in particular if this auxiliary light source 22 is an OLED. Furthermore, according to these two variants, a depth effect is additionally obtained.

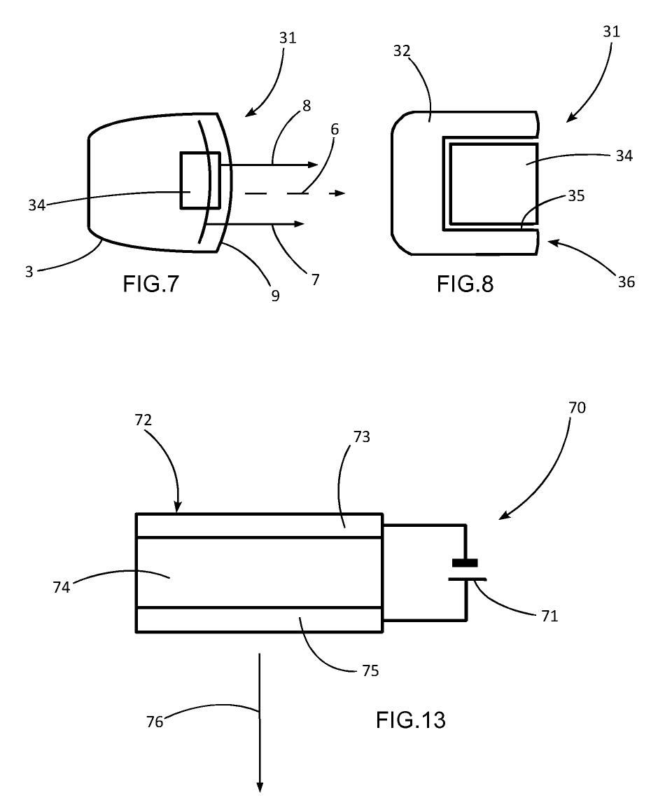

In a fourth embodiment, described hereafter with reference to FIGS. 7 and 8, the lighting and/or signaling device 31 differs from that described with reference to FIGS. 5 and 6 in that the main light source 34 is located on an edge 36 of the auxiliary light source 32. A cutout 35 can be made in the auxiliary light source 32 such that the main light source 34 can be placed in this cutout 35. The auxiliary light source 32 partly surrounds the main light source 34. The main light source 34 provides the photometry of the lighting and/or signaling function and the auxiliary light source 32 produces the signature of the lighting and/or signaling device 31. This signature is produced by the lighting-up of a surface partly surrounding the main light source 34.

Of course, the latter embodiment can be combined with the first two embodiments. Thus, the main light source 34 is not necessarily located in the middle or substantially in the middle of the auxiliary light source 32, but perhaps located at an edge of the latter, of which the main light source 34 is located in front or behind, or level with the auxiliary light source 32.

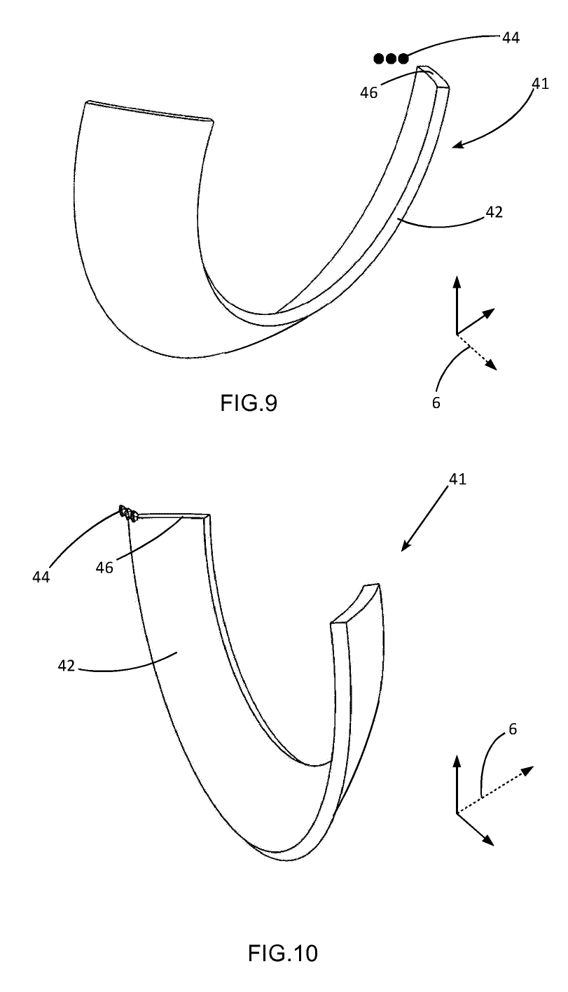

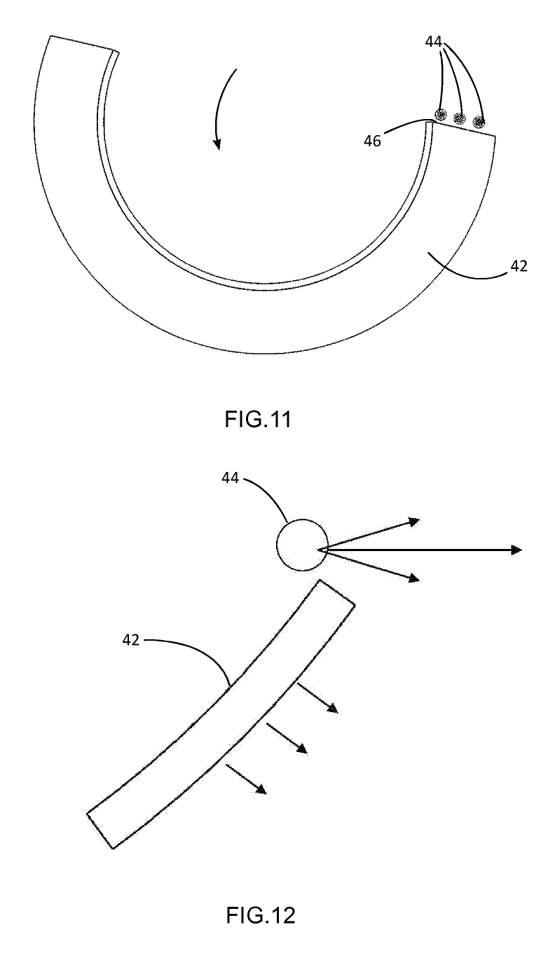

In a fifth embodiment, described hereafter with reference to FIGS. 9 to 12, the lighting and/or signaling device 41 differs from that described with reference to FIGS. 7 and 8 in that the main light source 44 is located at an edge 46 of the auxiliary light source 42, without a cutout being made in the auxiliary light source 42. The main light source 44 comprises several light-emitting diodes and the auxiliary light source 42 has substantially the shape of a part of a frustum of a cone.

The light rays 8 emitted by the main light source 44 and the light rays 7 emitted by the auxiliary light source 42 can be emitted at least substantially in the same direction. Nevertheless, they can also be emitted in very different directions able, for example, to form an angle of up to 90° or more between them. In particular, notably in applications of lamps with a large outer surface area, of the “wrap-around” lamp type, the light rays 8 emitted by the main light source 44 and the light rays 7 emitted by the auxiliary light source 42 can be emitted locally at least substantially in the same direction and emitted locally in very different directions. Indeed, the lighting and/or signaling function is performed at least substantially by the main light source 44. The auxiliary light source 42 has a signature function.

In the various embodiments, the auxiliary light source is of the surface type: it comprises at least one surface light source, preferably an organic light-emitting diode. The surface light source or sources can be of all types. Nevertheless, light sources of the organic light-emitting diode type are preferred. Such an organic light-emitting diode device 70 is represented in FIG. 13. The light-emitting diode device 70 comprises an organic light-emitting diode 72 and an electrical voltage generator 71. The organic light-emitting diode 72 comprises several layers: a cathode 73, an anode 75 and an organic layer 74. When the organic layer 74 is subjected to an electrical voltage, it emits light radiation 76 propagating through the anode 75 which is transparent in respect of this light radiation 76.

Preferably, the emitting area of the surface light source is greater than 1 cm², or even greater than 10 cm².

The auxiliary light source can comprise several surface elements emitting light, in particular several organic light-emitting diodes. The various surface light elements can be activated simultaneously or independently of one another. The various elements can be arranged edge-to-edge or otherwise, if necessary orienting their emission planes differently.

The auxiliary light source can be Lambertian or otherwise.

Preferably, the auxiliary source is implemented by a conformable organic light-emitting diode. For example, it can be implemented by a film which can be deposited on a surface, in particular on a warped surface. Alternatively, it can be implemented by virtue of a technique for printing various layers, in particular by a technique for printing on a warped surface. Thus, the auxiliary light source can exhibit a shape providing for following the curve of the cover lens 9 of the lighting and/or signaling device.

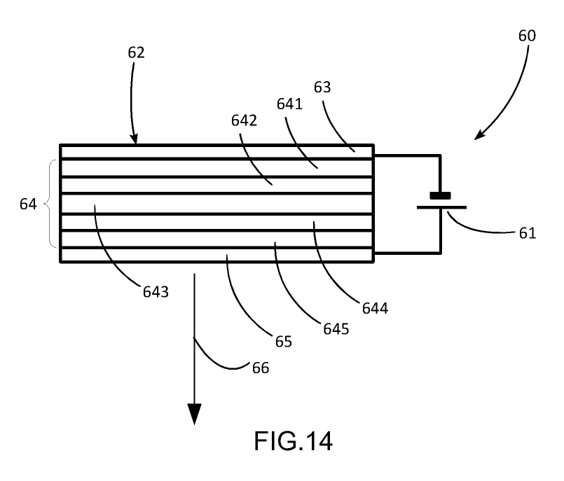

The main light source can be of all types. Preferably, it comprises one or more lamps combined with a reflector, or one or more light-emitting diodes, or LEDs, combined with a reflector. It can also comprise a system of optical lenses. The main light source can comprise an organic light-emitting diode. Such an organic light-emitting diode device 60 is represented in FIG. 14. The organic light-emitting diode device 60 comprises an organic light-emitting diode 62 and an electrical voltage generator 61. The organic light-emitting diode 62 comprises several layers: a cathode 63, an anode 65 and an organic layer 64. When the organic layer 64 is subjected to an electrical voltage, it emits light radiation 66 propagating through the anode 65 which is transparent in respect of this light radiation 66. The organic layer 64 can if necessary comprise various strata 641 to 645 made of various organic materials. Preferably, organic light-emitting diodes 62 comprising additional strata are used. In addition to the light-emitting stratum 643, the organic layer 64 comprises a stratum 641 encouraging the transport of electrons up to the emitting stratum 643 and a stratum 645 encouraging the transport of holes up to the emitting stratum 643. The organic layer 64 can also comprise a stratum 642 blocking the holes from the lower strata (643 to 645) and a stratum 644 blocking the electrons from the upper strata (641 to 643). All these strata form a microcavity, the thickness of which is adjusted to create an optical resonance. Thus, selective interferential reflectors are produced which form resonant cavities. For example, an organic light-emitting diode of the type described in document FR 2 926 677, which is equivalent to U.S. Patent Publication 2011/0079772, which documents are incorporated herein by reference and made a part hereof, can be used.

According to embodiments, it is possible to provide for the main and auxiliary light sources to emit light of different colors, the functions provided by the two sources being able to require different colors.

According to a preferred embodiment, the main and auxiliary light sources are activated simultaneously.

The main light source and the auxiliary light source preferably do not provide more than one lighting and/or signaling function. If necessary, the auxiliary light source completes the main light source to provide the lighting and/or signaling function.

In the case in which the auxiliary light source is implemented by several surface elements emitting light, it is possible to implement several zones able to be lit independently of one another. It is also possible to switch off a zone when the main source is on.

The lighting and/or signaling device according to the invention can be used, for example, to provide one of the following functions: high beam lighting, low beam lighting, fog beam lighting, vehicle position indication, direction change indication, reversing indication, braking indication, indication in the event of fog.

The invention can also be applied to the lighting of a passenger compartment of a motor vehicle, in particular a dome lamp.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. An optical device for a motor vehicle, in particular a lighting and/or signaling device for a motor vehicle, comprising a main light source and an auxiliary light source wherein said auxiliary light source comprises a surface light source.

2. The optical device as claimed in claim 1, wherein an area of emission of said surface light source is greater than 1 cm², or even greater than 10 cm².

3. The optical device as claimed in claim 1, wherein said surface light source comprises an organic light-emitting diode.

4. The optical device as claimed in claim 1, wherein an organic light-emitting diode is conformable.

5. The optical device as claimed in claim 1, wherein said lighting and/or signaling device comprises a housing closed by a cover lens, inside of said housing are located said main light source and said auxiliary light source.

6. The optical device as claimed in claim 5, wherein said auxiliary light source is located in between said cover lens and said main light source and in that said auxiliary light source is of the transparent type.

7. The optical device as claimed in claim 5, wherein said main light source is located in between said cover lens and said auxiliary light source.

8. The optical device as claimed in claim 1, wherein said auxiliary light source exhibits a cutout in which said main light source is arranged.

9. The optical device as claimed in claim 1, wherein said main light source is arranged at an edge of said lighting and/or signaling device and/or at an edge of said auxiliary light source.

10. The optical device as claimed in claim 1, wherein said main light source comprises several elements emitting light.

11. The optical device as claimed in claim 1, wherein said auxiliary light source comprises several surface elements emitting light, in particular several organic light-emitting diodes.

12. The optical device as claimed in claim 1, wherein said main light source and said auxiliary light source are activated simultaneously.

13. The optical device as claimed in claim 1, wherein a greater part of a lighting and/or signaling function is provided by said main light source.

14. The optical device as claimed in claim 1, wherein said main light source or sources fulfill a first photometric function and said auxiliary light source or sources fulfill a second photometric function that is different from said first photometric function.

15. The optical device as claimed in claim 1, wherein it is intended to provide an signaling function for a motor vehicle.

16. The optical device as claimed in claim 2, wherein said surface light source comprises an organic light-emitting diode.

17. The optical device as claimed in claim 3, wherein said organic light-emitting diode is conformable.

18. The optical device as claimed in claim 2, wherein said auxiliary light source exhibits a cutout in which said main light source is arranged.

19. The optical device as claimed in claim 3, wherein said auxiliary light source comprises several surface elements emitting light, in particular several organic light-emitting diodes.

20. The optical device as claimed in claim 3, wherein said main light source and said auxiliary light source are activated simultaneously.

21. The optical device as claimed in claim 3, wherein a greater part of a lighting and/or signaling function is provided by said main light source.

22. The optical device as claimed in claim 3, wherein said main light source or sources fulfill a first photometric function and said auxiliary light source or sources fulfill a second photometric function that is different from said first photometric function.
